(19) United States
(12) Patent Application Publication
(10) Pub. No.: US 2025/0383588 A1
(43) Pub. Date: Dec. 18, 2025

(54) IMAGE CAPTURE SYSTEMS INCLUDING REMOVABLE ACCESSORIES WITH HAPTIC COMPONENT(S)

(71) Applicant: GoPro, Inc., San Mateo, CA (US)

(72) Inventors: David Thomas Platner, San Francisco, CA (US); Nicholas Vitale, Foster City, CA (US); Ian Copeland Griggs, San Francisco, CA (US); Jonathan Michael Stern, San Mateo, CA (US)

(21) Appl. No.: 18/741,280

(22) Filed: Jun. 12, 2024

(51) Int. Cl. G03B 17/18; G03B 17/14; G03B 17/56

(52) U.S. Cl. CPC G03B 17/18; G03B 17/14; G03B 17/565

(57) ABSTRACT

An image capture system that includes an image capture apparatus and an accessory. The image capture apparatus includes a body and a mounting member that is connected to the body. The accessory is configured for releasable connection to the mounting member and includes at least one haptic component that is configured to provide an indication of positive connection of the accessory to the mounting member.

### TECHNICAL FIELD

The present disclosure relates to an image capture system that includes an image capture apparatus and an (optical) accessory that is configured for removable connection thereto. More specifically, the accessories described herein include haptic component(s) that provide tactile (and audible) indications of positive connection (and disconnection).

### BACKGROUND

Image capture apparatuses are used in a variety of applications, including, for example, handheld cameras and video recorders, cell phones, drones, etc. Such image capture apparatuses typically include (one or more) at least one optical element (e.g., a lens), which captures content by receiving and focusing light, and (one or more) at least one image sensor, which converts the captured content into an electronic image signal that is processes by an image processor. In some image capture apparatuses, the optical element(s) and the optical sensor(s) are integrated into a single unit, which is commonly known as an integrated sensor-lens assembly (ISLA).

Various accessories have been developed that are positionable adjacent to (about) the ISLA in order to protect the ISLA and/or vary the optical characteristics and/or capabilities of the image capture apparatus. Known accessories, however, generally rely upon a visual indication of proper connection to the image capture apparatus.

The present disclosure provides advancements in the connection (and disconnection) of accessories by incorporating haptic component(s) that provide tactile (and audible) indications of positive connection (and disconnection).

### SUMMARY

In one aspect of the present disclosure, an image capture system is disclosed that includes an image capture apparatus and an accessory. The image capture apparatus includes a body and a mounting member that is connected to the body. The accessory is configured for releasable connection to the mounting member and includes at least one haptic component that is configured to provide an indication of positive connection of the accessory to the mounting member.

In certain embodiments, the accessory may include at least one optical element.

In certain embodiments, the at least one haptic component may define a pocket that is configured to receive the mounting member.

In certain embodiments, the pocket may extend in generally parallel relation to the optical axis of the image capture apparatus.

In certain embodiments, the pocket may extend radially inward towards the optical axis of the image capture apparatus.

In certain embodiments, the at least one haptic component may include a static configuration.

In certain embodiments, the at least one haptic component may include a dynamic configuration.

In certain embodiments, the at least one haptic component may be resiliently repositionable between a normal position and a deflected position.

In certain embodiments, the at least one haptic component may include a first end that is fixedly connected to the accessory and a second, free end.

In certain embodiments, the at least one haptic component may be configured for axial deflection during repositioning between the normal position and the deflected position.

In certain embodiments, the at least one haptic component may be configured for radial deflection during repositioning between the normal position and the deflected position.

In another aspect of the present disclosure, an accessory is disclosed that is configured for use with an image capture apparatus that includes a mounting member. The accessory includes a frame with: slots that are configured to receive radial mounts on the mounting member; ramped sections that are in communication with the slots; and haptic components that are in communication with the ramped sections such that rotation of the accessory causes the radial mounts to engage the ramped sections and, thereafter, the haptic components to thereby provide an indication of positive connection of the accessory to the mounting member.

In certain embodiments, the frame may further include stops that are configured for engagement with the mounting member to thereby inhibit continued rotation of the accessory.

In certain embodiments, the stops may be positioned adjacent to the haptic components.

In certain embodiments, the ramped sections may be configured such that rotation of the accessory causes axial displacement thereof in relation to the mounting member.

In certain embodiments, the accessory may further include a sleeve that extends about the frame.

In certain embodiments, the sleeve may include a compliant material such that axial displacement of the accessory causes compression and expansion of the sleeve.

In certain embodiments, the haptic components may define pockets that are configured to receive the radial mounts.

In certain embodiments, the pockets may be axially offset in relation to the ramped sections along the optical axis of the image capture apparatus.

In certain embodiments, the pockets may include base walls that extend in generally orthogonal relation to the optical axis.

In another aspect of the present disclosure, an accessory is disclosed that is configured for use with an image capture apparatus that includes a mounting member. The accessory includes: a barrel; a lens that is connected to the barrel; a frame that is connected to the barrel; and a sleeve that extends about the frame. The frame is configured to interface with radial mounts on the mounting member such that the accessory is rotatable in relation to the mounting member between a disengaged position, in which the accessory is connectable to and disconnectable from the image capture apparatus, and an engaged position, in which the accessory is connected to the image capture apparatus via the mounting member.

The frame includes: slots that extend axially into the frame in generally parallel relation to the optical axis of the image capture apparatus and which are configured to receive the radial mounts; ramped sections that are in communication with the slots and which are configured to engage the radial mounts such that the accessory is displaced axially during rotation between the disengaged position and the engaged position; and haptic components that are in communication with the ramped sections and which are configured to interface with the radial mounts to thereby provide an indication of positive connection of the accessory to the mounting member.

The sleeve includes a compliant material such that axial displacement of the accessory causes compression and expansion of the sleeve.

In certain embodiments, the haptic components may define pockets that are configured to receive the radial mounts.

In certain embodiments, the accessory may be configured for rotation through an angular range of motion that is less than 90 degrees during rotation between the disengaged position and the engaged position.

### BRIEF DESCRIPTION OF THE DRAWINGS

The present disclosure is best understood from the following detailed description when read in conjunction with the accompanying drawings. According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIG. 4 is a block diagram of electronic components of an image capture apparatus.

FIG. 5 is a front, plan view of an image capture system that includes another example of an image capture apparatus, which includes a mounting member, and an accessory that is configured for removable connection to the mounting member.

FIG. 6 is a partial cross-sectional view taken through line 6-6 in FIG. 5.

FIG. 7 is a front, perspective view of the image capture system with the accessory shown separated from the image capture apparatus.

FIG. 8 is a rear, plan view of the accessory.

FIG. 9 is a partial, front, perspective view illustrating connection of the accessory to the mounting member.

FIG. 10 is a front, perspective view of the accessory shown with parts separated.

FIG. 11 is a partial, front, perspective view of the accessory.

FIG. 12 is a partial, cross-sectional view of the accessory.

FIG. 13 is a partial, rear, perspective view of another example of the accessory, which is shown with the mounting member and in a disengaged position.

FIG. 14 is a partial, rear, perspective view of the accessory seen in FIG. 13, which is shown with the mounting member and in an engaged position.

FIG. 15 is a partial, front, cross-sectional view of another example of the accessory, which is shown in perspective with the mounting member and in the engaged position.

FIG. 16 is a partial, front, cross-sectional view of another example of the accessory, which is shown in perspective with the mounting member and in the engaged position.

FIG. 17 is a partial, front, cross-sectional view of another example of the accessory, which is shown in perspective with the mounting member and in the disengaged position.

FIG. 18 is a partial, rear, cross-sectional view of the accessory seen in FIG. 17, which is shown in perspective with the mounting member in the disengaged position.

FIG. 19 is a partial, front, end view of the accessory and the mounting member seen in FIG. with the accessory shown in the disengaged position.

FIG. 20 is a partial, front, end view of the accessory and the mounting member seen in FIG. 17 with the accessory shown in the engaged position.

FIG. 21 is a partial, front, cross-sectional view of another example of the accessory, which is shown in perspective with the mounting member and in the engaged position.

FIG. 22 is a partial, front, cross-sectional view of another example of the accessory, which is shown in perspective with the mounting member and in the engaged position.

FIG. 23 is a partial, front, cross-sectional view of another example of the accessory, which is shown in perspective with the mounting member and in the disengaged position.

FIG. 24 is a partial, front, perspective view of the accessory and the mounting member seen in FIG. 23 with the accessory shown in the disengaged position.

FIG. 25 is a partial, front, perspective view of the accessory and the mounting member seen in FIG. 23 with the accessory shown in the engaged position.

FIG. 26 is a rear, perspective view of another example of the accessory, which is shown with the mounting member in the disengaged position.

### DETAILED DESCRIPTION

The present disclosure describes an image capture system that includes an image capture apparatus with a mounting member and an (optical) accessory that is configured for removable connection thereto. The accessory includes (one or more) at least one haptic component, which may include either a static (i.e., fixed) configuration or a dynamic configuration, that is configured to provide an indication of positive connection of the accessory to the mounting member. For example, in certain embodiments, the haptic component(s) include pocket(s) that are formed in (defined by) a frame of the accessory and which are configured to receive the mounting member, whereas in other embodiments, the haptic component(s) include (radially or axially) deflectable arm(s) that are configured for engagement (contact) with the mounting member.

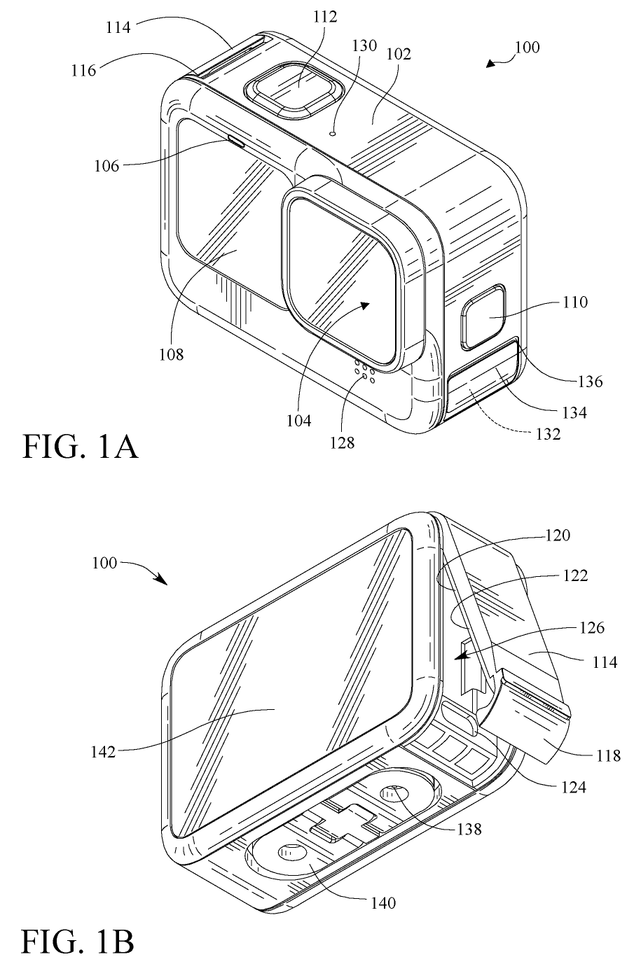

FIGS. 1A–1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A–1B, the image capture apparatus 100 includes internal electronics, such as imaging electronics, power electronics, and the like, internal to the body 102 for capturing images and performing other functions of the image capture apparatus 100. The arrangement of the components of the image capture apparatus 100 shown in FIGS. 1A–1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be connected (secured) to the body 102 using the latch mechanism 118 that releasably engages (contacts) the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages (contacts) a flange (not shown) to provide an environmental seal and the battery interface 122 engages (contacts) the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptable 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is positioned (located) behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects (secures) the image capture apparatus 100 to an external structure, such as a handle grip, another mount, or a securing device. The interconnect mechanism 140 includes folding protrusions configured to move between a collapsed (nested) configuration as shown in FIG. 1B and an extended (open) configuration. The folding protrusions of the interconnect mechanism 140 in the extended configuration may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A–1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

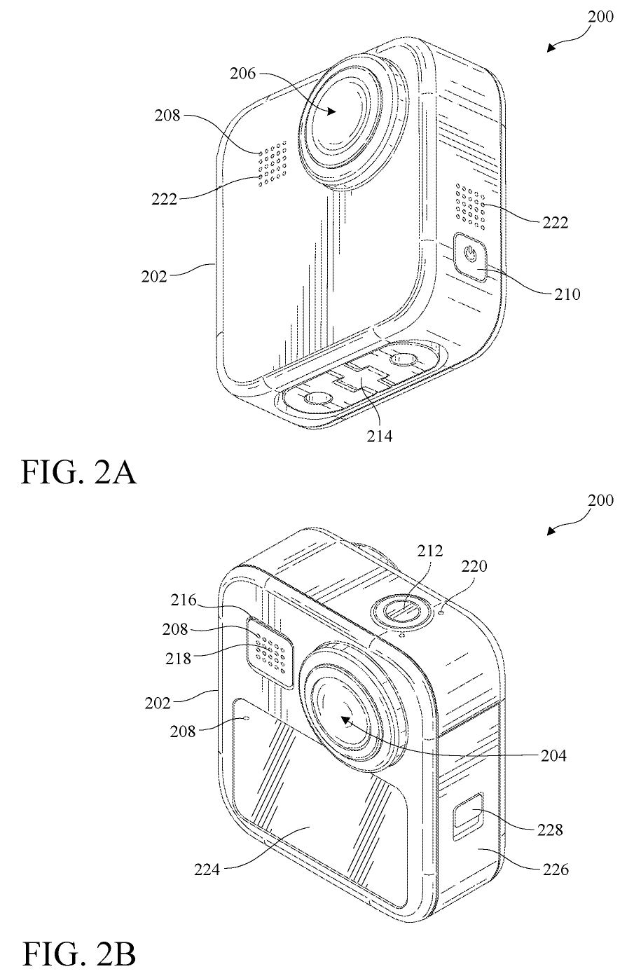

FIGS. 2A–2B illustrate another example of an image capture apparatus 200. The image capture apparatus 200 is similar to the image capture apparatus 100 shown in FIGS. 1A–1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A–2B is an example, other arrangements of elements may be used.

The body 202 of the image capture apparatus 200 may be similar to the body 102 shown in FIGS. 1A–1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposite surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A–2B, the image capture apparatus 200 may include other indictors structured on respective surfaces of the body 202.

As shown in FIGS. 2A–B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

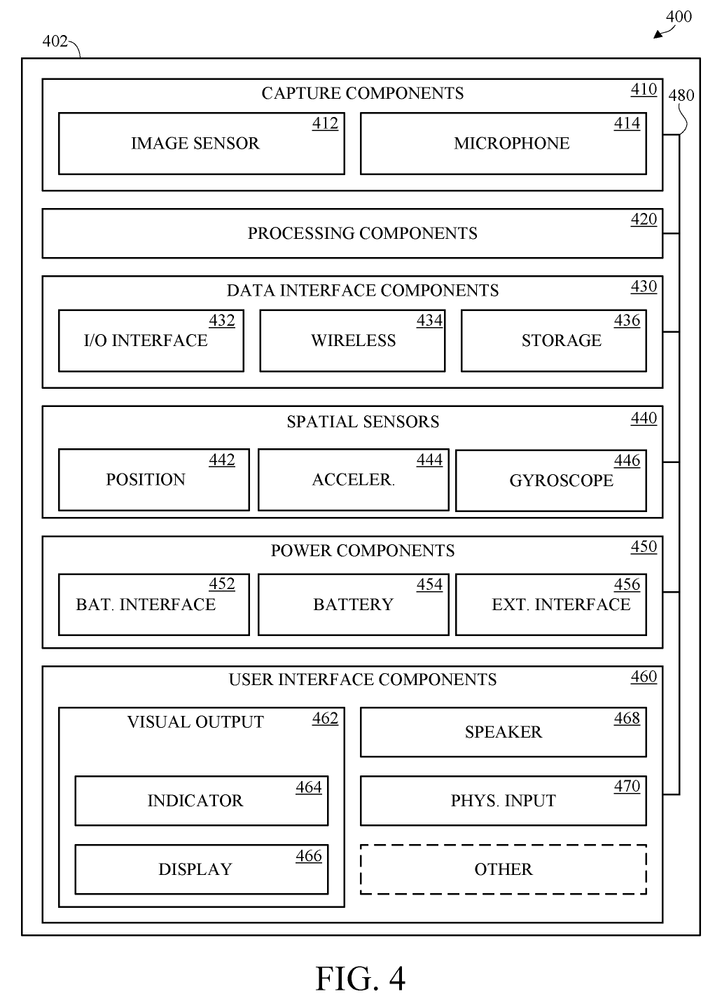

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 4.

As shown in FIGS. 2A–2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A–2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A–1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A–2B, a first audio component 218 is positioned (located) on a front surface of the body 202, a second audio component 220 is positioned (located) on a top surface of the body 202, and a third audio component 222 is positioned (located) on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A–1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

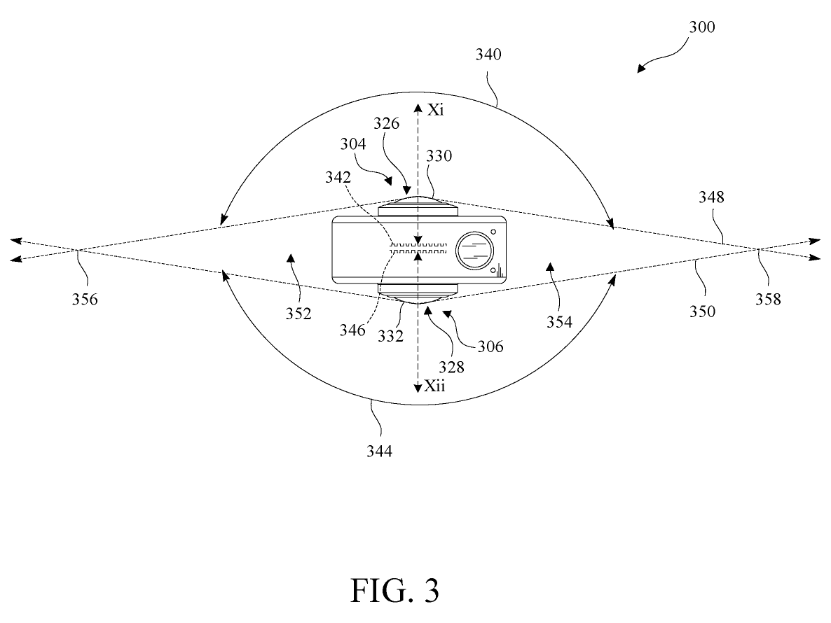

FIG. 3 is a top view of an image capture apparatus 300. The image capture apparatus 300 is similar to the image capture apparatus 200 of FIGS. 2A–2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342. In the illustrated embodiment, the first lens 330 and the first image sensor 342 are integrated into a single unit, whereby the first image capture device 304 is configured as a first ISLA 326 that defines a first optical axis Xi.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346. In the illustrated embodiment, the second lens 332 and the second image sensor 346 are integrated into a single unit, whereby the second image capture device 306 is configured as a second ISLA 328 that defines a second optical axis Xii.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions (e.g., a forward direction and a rearward direction), and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The ISLAs 326, 328 (e.g., the lenses 330, 332) may be aligned as shown (e.g., such that the optical axes Xi, Xii are coincident with each other), laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

FIG. 4 is a block diagram of electronic components in an image capture apparatus 400. The image capture apparatus 400 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A–B, the image capture apparatus 200 shown in FIGS. 2A–B, or the image capture apparatus 300 shown in FIG. 3, may be implemented as shown in FIG. 4.

The image capture apparatus 400 includes a body 402. The body 402 may be similar to the body 102 shown in FIGS. 1A–1B or the body 202 shown in FIGS. 2A–2B. The body 402 includes electronic components such as capture components 410, processing components 420, data interface components 430, spatial sensors 440, power components 450, user interface components 460, and a bus 480.

The capture components 410 include an image sensor 412 for capturing images. Although one image sensor 412 is shown in FIG. 4, the capture components 410 may include multiple image sensors. The image sensor 412 may be similar to the image sensors 342, 346 shown in FIG. 3. The image sensor 412 may be, for example, a charge-coupled device (CCD) sensor, an active pixel sensor (APS), a complementary metal–oxide–semiconductor (CMOS) sensor, or an N-type metal–oxide–semiconductor (NMOS) sensor. The image sensor 412 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 412 captures detected light as image data and conveys the captured image data as electrical signals (image signals or image data) to the other components of the image capture apparatus 400, such as to the processing components 420, such as via the bus 480.

The capture components 410 include a microphone 414 for capturing audio. Although one microphone 414 is shown in FIG. 4, the capture components 410 may include multiple microphones. The microphone 414 detects and captures, or records, sound, such as sound waves incident upon the microphone 414. The microphone 414 may detect, capture, or record sound in conjunction with capturing images by the image sensor 412. The microphone 414 may detect sound to receive audible commands to control the image capture apparatus 400. The microphone 414 may be similar to the microphones 128, 130, 132 shown in FIGS. 1A–1B or the audio components 218, 220, 222 shown in FIGS. 2A–2B.

The processing components 420 perform image signal processing, such as filtering, tone mapping, or stitching, to generate, or obtain, processed images, or processed image data, based on image data obtained from the image sensor 412. The processing components 420 may include one or more processors having single or multiple processing cores. In some implementations, the processing components 420 may include, or may be, an application specific integrated circuit (ASIC) or a digital signal processor (DSP). For example, the processing components 420 may include a custom image signal processor. The processing components 420 conveys data, such as processed image data, with other components of the image capture apparatus 400 via the bus 480. In some implementations, the processing components 420 may include an encoder, such as an image or video encoder that may encode, decode, or both, the image data, such as for compression coding, transcoding, or a combination thereof.

Although not shown expressly in FIG. 4, the processing components 420 may include memory, such as a random-access memory (RAM) device, which may be non-transitory computer-readable memory. The memory of the processing components 420 may include executable instructions and data that can be accessed by the processing components 420.

The data interface components 430 communicates with other, such as external, electronic devices, such as a remote control, a smartphone, a tablet computer, a laptop computer, a desktop computer, or an external computer storage device. For example, the data interface components 430 may receive commands to operate the image capture apparatus 400. In another example, the data interface components 430 may transmit image data to transfer the image data to other electronic devices. The data interface components 430 may be configured for wired communication, wireless communication, or both. As shown, the data interface components 430 include an I/O interface 432, a wireless data interface 434, and a storage interface 436. In some implementations, one or more of the I/O interface 432, the wireless data interface 434, or the storage interface 436 may be omitted or combined.

The I/O interface 432 may send, receive, or both, wired electronic communications signals. For example, the I/O interface 432 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 432 is shown in FIG. 4, the data interface components 430 include multiple I/O interfaces. The I/O interface 432 may be similar to the data interface 124 shown in FIG. 1B.

The wireless data interface 434 may send, receive, or both, wireless electronic communications signals. The wireless data interface 434 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 434 is shown in FIG. 4, the data interface components 430 include multiple wireless data interfaces. The wireless data interface 434 may be similar to the data interface 124 shown in FIG. 1B.

The storage interface 436 may include a memory card connector, such as a memory card receptacle, configured to receive and operatively couple to a removable storage device, such as a memory card, and to transfer, such as read, write, or both, data between the image capture apparatus 400 and the memory card, such as for storing images, recorded audio, or both captured by the image capture apparatus 400 on the memory card. Although one storage interface 436 is shown in FIG. 4, the data interface components 430 include multiple storage interfaces. The storage interface 436 may be similar to the data interface 124 shown in FIG. 1B.

The spatial, or spatiotemporal, sensors 440 detect the spatial position, movement, or both, of the image capture apparatus 400. As shown in FIG. 4, the spatial sensors 440 include a position sensor 442, an accelerometer 444, and a gyroscope 446. The position sensor 442, which may be a global positioning system (GPS) sensor, may determine a geospatial position of the image capture apparatus 400, which may include obtaining, such as by receiving, temporal data, such as via a GPS signal. The accelerometer 444, which may be a three-axis accelerometer, may measure linear motion, linear acceleration, or both of the image capture apparatus 400. The gyroscope 446, which may be a three-axis gyroscope, may measure rotational motion, such as a rate of rotation, of the image capture apparatus 400. In some implementations, the spatial sensors 440 may include other types of spatial sensors. In some implementations, one or more of the position sensor 442, the accelerometer 444, and the gyroscope 446 may be omitted or combined.

The power components 450 distribute electrical power to the components of the image capture apparatus 400 for operating the image capture apparatus 400. As shown in FIG. 4, the power components 450 include a battery interface 452, a battery 454, and an external power interface 456 (ext. interface). The battery interface 452 (bat. interface) operatively couples to the battery 454, such as via conductive contacts to transfer power from the battery 454 to the other electronic components of the image capture apparatus 400. The battery interface 452 may be similar to the battery receptacle 126 shown in FIG. 1B. The external power interface 456 obtains or receives power from an external source, such as a wall plug or external battery, and distributes the power to the components of the image capture apparatus 400, which may include distributing power to the battery 454 via the battery interface 452 to charge the battery 454. Although one battery interface 452, one battery 454, and one external power interface 456 are shown in FIG. 4, any number of battery interfaces, batteries, and external power interfaces may be used. In some implementations, one or more of the battery interface 452, the battery 454, and the external power interface 456 may be omitted or combined. For example, in some implementations, the external interface 456 and the I/O interface 432 may be combined.

The user interface components 460 receive input, such as user input, from a user of the image capture apparatus 400, output, such as display or present, information to a user, or both receive input and output information, such as in accordance with user interaction with the image capture apparatus 400.

As shown in FIG. 4, the user interface components 460 include visual output components 462 to visually communicate information, such as to present captured images. As shown, the visual output components 462 include an indicator 464 and a display 466. The indicator 464 may be similar to the indicator 106 shown in FIG. 1A or the indicators 208 shown in FIGS. 2A–2B. The display 466 may be similar to the display 108 shown in FIG. 1A, the display 142 shown in FIG. 1B, or the display 224 shown in FIG. 2B. Although the visual output components 462 are shown in FIG. 4 as including one indicator 464, the visual output components 462 may include multiple indicators. Although the visual output components 462 are shown in FIG. 4 as including one display 466, the visual output components 462 may include multiple displays. In some implementations, one or more of the indicators 464 or the display 466 may be omitted or combined.

As shown in FIG. 4, the user interface components 460 include a speaker 468. The speaker 468 may be similar to the speaker 138 shown in FIG. 1B or the audio components 218, 220, 222 shown in FIGS. 2A–2B. Although one speaker 468 is shown in FIG. 4, the user interface components 460 may include multiple speakers. In some implementations, the speaker 468 may be omitted or combined with another component of the image capture apparatus 400, such as the microphone 414.

As shown in FIG. 4, the user interface components 460 include a physical input interface 470. The physical input interface 470 may be similar to the mode buttons 110, 210 shown in FIGS. 1A, 2A or the shutter buttons 112, 212 shown in FIGS. 1A, 2B. Although one physical input interface 470 is shown in FIG. 4, the user interface components 460 may include multiple physical input interfaces. In some implementations, the physical input interface 470 may be omitted or combined with another component of the image capture apparatus 400. The physical input interface 470 may be, for example, a button, a toggle, a switch, a dial, or a slider.

As shown in FIG. 4, the user interface components 460 include a broken line border box labeled “other” to indicate that components of the image capture apparatus 400 other than the components expressly shown as included in the user interface components 460 may be user interface components. For example, the microphone 414 may receive, or capture, and process audio signals to obtain input data, such as user input data corresponding to voice commands. In another example, the image sensor 412 may receive, or capture, and process image data to obtain input data, such as user input data corresponding to visible gesture commands. In another example, one or more of the spatial sensors 440, such as a combination of the accelerometer 444 and the gyroscope 446, may receive, or capture, and process motion data to obtain input data, such as user input data corresponding to motion gesture commands.

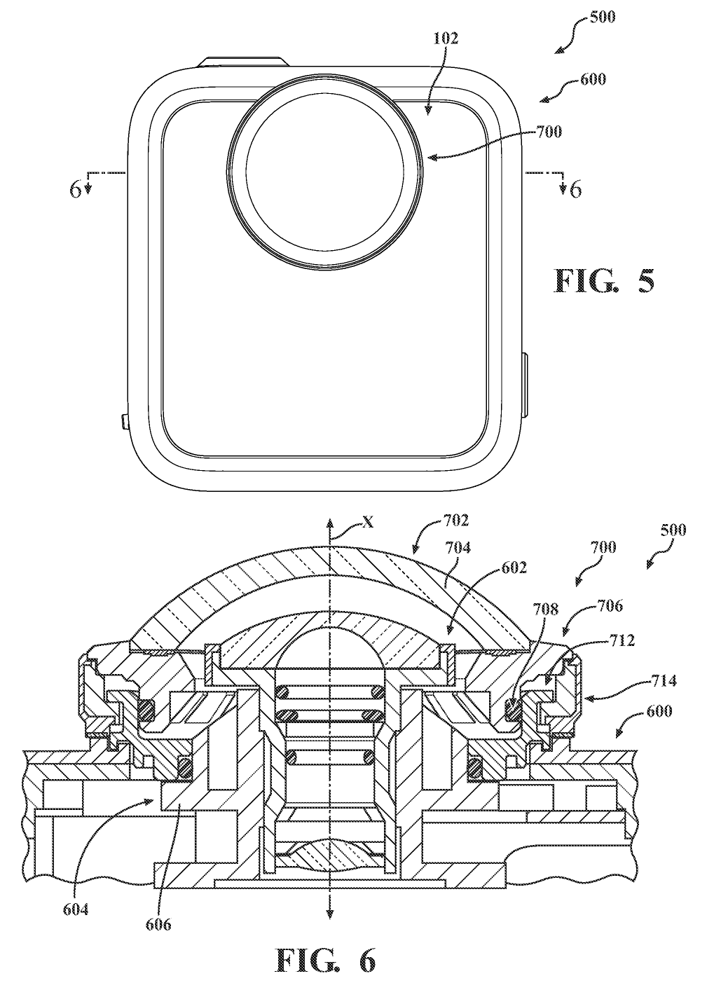

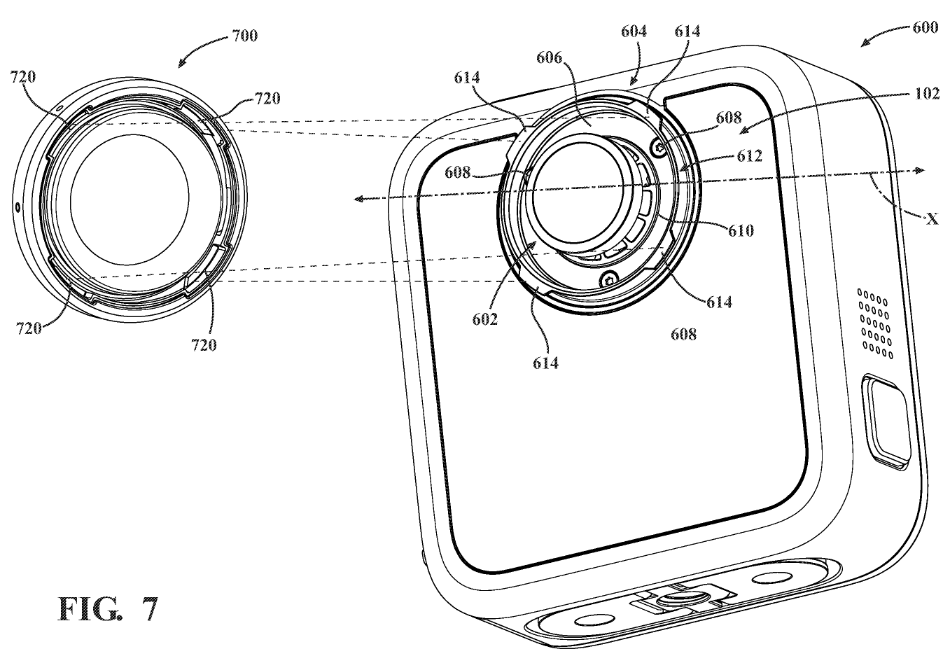

FIGS. 5-7 illustrate an image capture system 500 that includes an image capture apparatus 600 and an (optical) accessory 700 for use therewith, which is configured for removable connection to the image capture apparatus 600. More specifically, FIG. 5 is a front, plan view of the image capture system 500 with the accessory 700 shown connected (secured) to the image capture apparatus 600; FIG. 6 is a partial cross-sectional view taken through line 6-6 in FIG. 5; and FIG. 7 is a front, perspective view of the image capture system with the accessory 700 shown separated from the image capture apparatus 600.

The image capture apparatus 600 includes features that are similar to the image capture apparatuses 100 (FIGS. 1A, 1B), 200 (FIGS. 2A, 2B), 300 (FIG. 3), and 400 (FIG. 4) discussed above and, accordingly, will only be discussed with respect to differences therefrom in the interest of brevity. As such, identical reference characters will be utilized to refer to elements, structures, features, etc., common to the image capture apparatuses 100, 200, 300, 400, 600. Although illustrated in connection with the image capture apparatus 600, it is envisioned that the accessory 700 may be configured for use with a wide variety of image capture apparatuses including, for example, the image capture apparatus 100, 200, 300, 400, etc.

The image capture apparatus 600 defines an optical axis X (FIGS. 6, 7, 12) and includes an ISLA 602, which is similar (e.g., identical) to the ISLAs 326, 328 (FIG. 3), and a mounting member 604 (FIGS. 6, 7) (e.g., a bayonet 606), which is (mechanically) connected (secured) to both the body 102 of the image capture apparatus 600 and the ISLA 602 (e.g., via fasteners 608). To reduce (if not entirely prevent) the ingress of water, dirt, debris, etc., into the image capture apparatus 600 (e.g., upon removal of the accessory 700), one or more sealing members (e.g., O-rings, gaskets, or the like) may be utilized to form a watertight seal between the mounting member 604, the body 102 of the image capture apparatus 600, and/or the ISLA 602.

While it is envisioned that the mounting member 604 may include any suitable material or combination of materials, in the illustrated embodiment, the mounting member 604 includes (e.g., is formed partially or entirely from) stainless steel, which not only reduces wear on the mounting member 604 that may otherwise result from repeated connection and disconnection of the accessory 700 but improves user feel.

The mounting member 604 defines a (central) opening 610 that is configured to receive the ISLA 602 such that the ISLA 602 extends through the mounting member 604. As seen in FIG. 7, the mounting member 604 includes a (front) collar 612 and radial mounts 614, which are generally identical in configuration and each extend radially outward from the collar 612. More specifically, in the illustrated embodiment, the collar 612 and the radial mounts 614 are integrally (unitarily, monolithically) formed from a single piece of (metallic) material. As described in further detail below, the radial mounts 614 are configured for releasable engagement with the accessory 700 such that the accessory 700 is connectable to and disconnectable from the image capture apparatus 600 via the mounting member 604.

Although shown as including four radial mounts 614 that are angularly (circumferentially) separated by approximately 90 degrees, it should be appreciated that the particular number, location, and/or configuration of the radial mounts 614 may be varied in alternative embodiments without departing from the scope of the present disclosure (e.g., depending upon the particular configuration of the accessory 700).

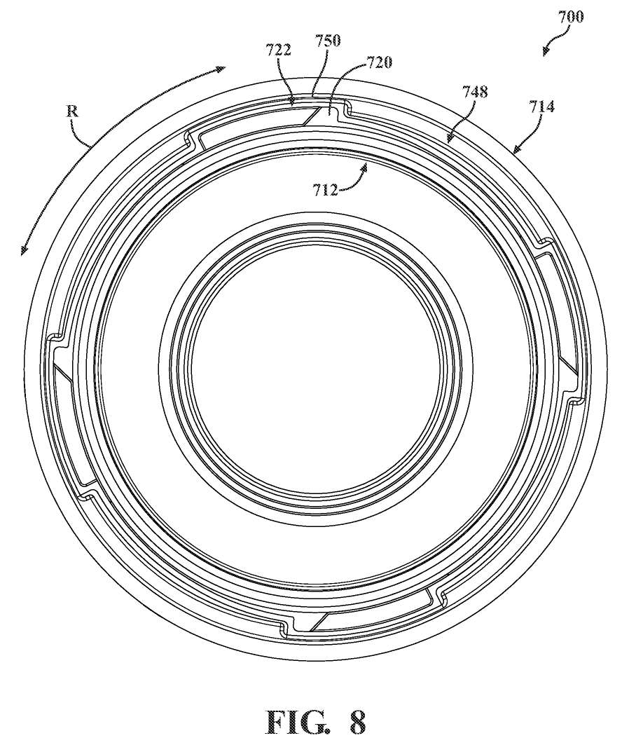

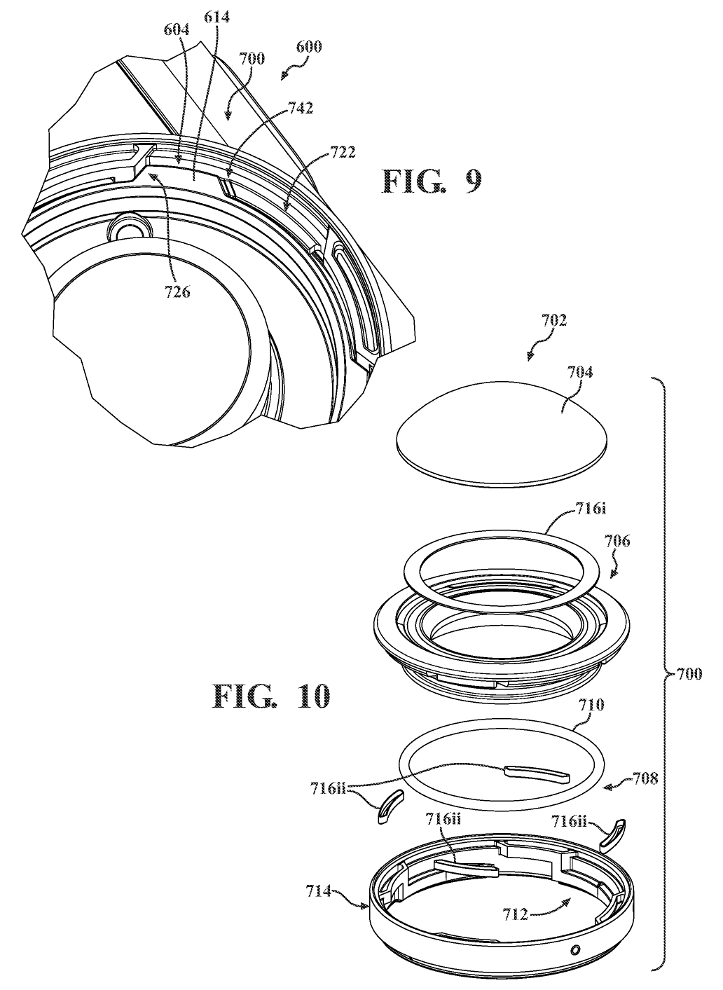

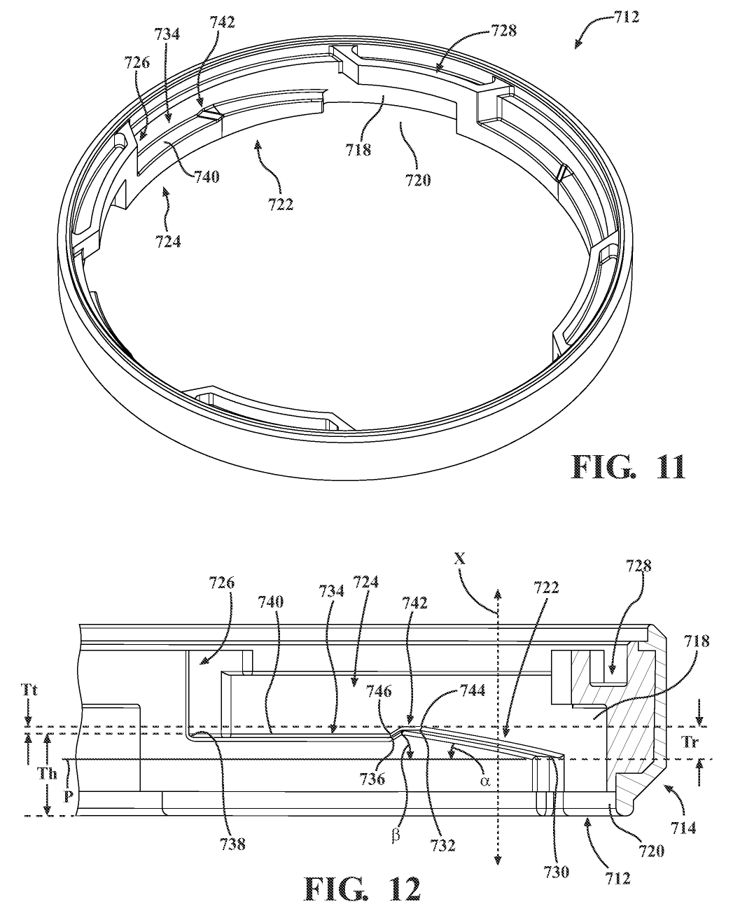

With reference now to FIGS. 8-12, the accessory 700 will be discussed. More specifically, FIG. 8 is a rear, plan view of the accessory 700; FIG. 9 is a partial, front, perspective view illustrating connection of the accessory 700 to the mounting member 604; FIG. 10 is a front, perspective view of the accessory 700 shown with parts separated; FIG. 11 is a partial, front, perspective view of the accessory 700; and FIG. 12 is a partial, cross-sectional view of the accessory 700.

The accessory 700 is configured for releasable connection to the image capture apparatus 600 (i.e., the mounting member 604) and functions as a removable cap that protects and conceals the ISLA 602. More specifically, the accessory 700 is repositionable (i.e., rotatable) in relation to the mounting member 604 between a disengaged (unlocked) position (FIG. 7), in which the accessory 700 is connectable to and disconnectable from the image capture apparatus 600 (i.e., the mounting member 604), and an engaged (locked) position (FIG. 9), in which the accessory 700 is connected (secured) to the image capture apparatus 600 (i.e., the mounting member 604). The accessory 700 includes: (one or more) at least one optical element 702 (e.g., a lens 704); a barrel 706; a sealing member 708 (e.g., an O-ring 710); a frame 712; and an (outer) sleeve 714.

The barrel 706 supports the optical element 702 and is connected (secured) thereto via (one or more) at least one adhesive member 716i. The barrel 706 is non-metallic in construction and, more specifically, in the illustrated embedment, is manufactured via injection molding such that the barrel 706 is integrally (unitarily, monolithically) formed from a single piece of material (e.g., polycarbonate). Alternative methods of manufacturing the barrel 706 and/or materials of construction are also envisioned herein, however, and would not be beyond the scope of the present disclosure.

The sealing member 708 is located internally within the accessory 700. More specifically, as seen in FIG. 6, the sealing member 708 is positioned (located) between the barrel 706 and the frame 712 to thereby seal the accessory 700 against the ingress of water, dirt, debris, etc.

The frame 712 is connected (secured) to the barrel 706 via (one or more) at least one adhesive member 716ii. The frame 712 is metallic in construction, which inhibits (if not entirely prevents) wear on the mounting member 604 and the accessory 700 during connection and disconnection. More specifically, in the illustrated embodiment, the frame 712 is manufactured using metal injection molding (MIM) such that the frame 712 is integrally (unitarily, monolithically) formed from a single piece of material (e.g., stainless steel). Alternative methods of manufacturing the frame 712 and/or materials of construction are also envisioned herein, however, and would not be beyond the scope of the present disclosure.

The frame 712 is configured to interface with the radial mounts 614 during rotation of the accessory 700 between the disengaged position and the engaged position. With reference to FIGS. 11 and 12 in particular, the frame 712 is generally annular (e.g., circular) in cross-sectional configuration and includes: an inner wall 718; slots 720; ramped sections 722; haptic components 724; and stops 726.

The slots 720 extend axially into the frame 712 (i.e., in generally parallel relation to the optical axis X (FIGS. 6, 7, 12). The slots 720 are configured in correspondence with (i.e., mirror) and receive the radial mounts 614 (FIGS. 7, 9) on the mounting member 604 when the accessory 700 is in the disengaged position (FIG. 7). As such, in the illustrated embodiment, the frame 712 includes four slots 720 that are angularly (circumferentially) separated by approximately 90 degrees. It should be appreciated, however, that the particular number, location, and/or configuration of the slots 720 may be varied in alternative embodiments without departing from the scope of the present disclosure (e.g., depending upon the particular configuration of the mounting member 604).

In the illustrated embodiment, the frame 712 further includes awnings 728, which extend radially inward from the inner wall 718 (i.e., towards the optical axis X) and are angularly (circumferentially) aligned with the slots 720. As such, in the illustrated embodiment, the frame 712 includes four awnings 728 that are angularly (circumferentially) separated by approximately 90 degrees. It should be appreciated, however, that the particular number, location, and/or configuration of the awnings 728 may be varied in alternative embodiments without departing from the scope of the present disclosure (e.g., depending upon the particular configuration of the mounting member 604).

The awnings 728 are configured to interface with (i.e., engage, contact) the radial mounts 614 upon insertion into the slots 720, which inhibits (if not entirely prevents) over-advancement of the accessory 700 and facilitates proper orientation of the accessory 700 in relation to the mounting member 604. More specifically, upon insertion of the radial mounts 614 into the slots 720, the awnings 728 facilitate alignment of the radial mounts 614 and the ramped sections 722 and, thus, proper engagement of the accessory 700 and the mounting member, which is described in further detail below. Embodiments of the accessory 700 that are devoid of the awnings 728 are also envisioned herein, however, and would not be beyond the scope of the present disclosure.

The ramped sections 722 are positioned (located) adjacent to the slots 720 and are in communication therewith such that, upon entering the slots 720, the radial mounts 614 are positioned for engagement (contact) with the ramped sections 722. As such, in the illustrated embodiment, the frame 712 includes four ramped sections 722 that are angularly (circumferentially) separated by approximately 90 degrees. It should be appreciated, however, that the particular number, location, and/or configuration of the ramped sections 722 may be varied in alternative embodiments without departing from the scope of the present disclosure (e.g., depending upon the particular configuration of the mounting member 604).

As seen in FIGS. 11 and 12, the ramped sections 722 extend radially inward from the inner wall 718 (i.e., towards the optical axis X) and include opposite (first and second) ends 730, 732. The ramped sections 722 define thicknesses (heights) Tr, which extend in generally parallel relation to the optical axis X. The thicknesses Tr vary between the ends 730, 732 of the ramped sections 722 such that the ramped sections 722 are tapered in configuration. More specifically, the thicknesses Tr of the ramped sections 722 increase gradually (e.g., uniformly) from the end 730 towards the end 732 such that the ramped sections 722 are inclined in relation to a reference plane P that extends in generally orthogonal (perpendicular) relation to the optical axis X.

In the illustrated embodiment, the ramped sections 722 are configured so as to subtend (acute) angles α with the reference plane P that lie substantially within the range of approximately 10 degrees to approximately 45 degrees. Embodiments in which the accessory 700 may be configured such that the angles α lie outside the disclosed range are also envisioned herein, however, and would not be beyond the scope of the present disclosure.

Upon engagement of the radial mounts 614 with the ramped sections 722, as the accessory 700 is rotated in relation to the image capture apparatus 600 (e.g., the mounting member 604) during connection, the radial mounts 614 traverse the ramped sections 722, whereby the accessory 700 is displaced axially inward (i.e., towards the image capture apparatus 600). Oppositely, during disconnection of the accessory 700, as the radial mounts 614 traverse the ramped sections 722, the accessory 700 is displaced axially outward (i.e., away from the image capture apparatus 600).

By virtue of the varying thicknesses Tr, as the radial mounts 614 traverse the ramped sections 722, the force required to continue rotation of the accessory 700 increases during connection and decreases during disconnection. In various embodiments of the accessory 700, it is envisioned that the severity of the angles α may be altered in order to alter the force required to rotate the accessory 700 and/or the axial displacement experienced by the accessory 700 during connection and disconnection.

In the illustrated embodiment, the ramped sections 722 are configured for engagement (contact) with the radial mounts 614 upon clockwise rotation of the accessory 700. Embodiments in which the configurations of the ramped sections 722 may be reversed (i.e., such that the ramped sections 722 are configured for engagement (contact) with the radial mounts 614 upon counterclockwise rotation of the accessory 700) are also envisioned herein, however, and would not be beyond the scope of the present disclosure.

The haptic components 724 are positioned (located) adjacent to the ramped sections 722 and are in communication therewith such that, upon traversing the ramped sections 722, the radial mounts 614 interface with (i.e., engage, contact) the haptic components 724. As such, in the illustrated embodiment, the frame 712 includes four haptic components 724 that are angularly (circumferentially) separated by approximately 90 degrees. It should be appreciated, however, that the particular number, location, and/or configuration of the haptic components 724 may be varied in alternative embodiments without departing from the scope of the present disclosure (e.g., depending upon the particular configuration of the mounting member 604). For example, embodiments of the accessory 700 that include a single haptic component 724 are also envisioned herein.

In the illustrated embodiment, the haptic components 724 extend radially inward from the inner wall 718 (i.e., towards the optical axis X (FIGS. 6, 7, 12)) and include a static (fixed) configuration. More specifically, the haptic components 724 define pockets 734, which include opposite (first and second) ends 736, 738 and define base walls 740. As seen in FIG. 12, the base walls 740 extend in generally parallel relation to the reference plane P and in generally orthogonal (perpendicular) relation to the optical axis X, whereby the haptic components 724 define thicknesses (heights) Th (FIG. 12) that are generally uniform (consistent) between the ends 736, 738 of the pockets 734.

The pockets 734 extend in generally parallel relation to the optical axis X and are recessed (axially offset) in relation to the ramped sections 722 (i.e., towards the image capture apparatus 600, along the optical axis X). The pockets 734 are configured to receive the radial mounts 614 when the accessory 700 is in the engaged position, as seen in FIG. 9, such that, upon insertion of the radial mounts 614 into the pockets 734, the accessory 700 is displaced axially outward (i.e., away from the image capture apparatus 600, along the optical axis X). Axially outward displacement of the accessory 700 provides a tactile indication that the accessory 700 is properly connected (secured) to the image capture apparatus 600 (i.e., the mounting member 604), which may be supplemented by an audible indication resulting from engagement (contact) between the radial mounts 614 and the base walls 740 upon insertion of the radial mounts 614 into the pockets 734.

The tactile (and audible) indications provided by the haptic components 724 eliminate the need for obvious visual indicator(s) that may otherwise be required in order to identify proper connection (and disconnection) of the accessory 700, thereby improving the overall aesthetic appearance of the image capture system 500 as a whole.

As seen in FIG. 12, in the illustrated embodiment, the frame 712 further includes transitions 742, which are positioned (located) adjacent to and between the ramped sections 722 and the haptic components 724 (i.e., the pockets 734) and are in communication therewith such that the radial mounts 614 interface with (i.e., engage, contact) the transitions 742 during travel between the ramped sections 722 and the pockets 734 and during travel between the pockets 734 and the ramped sections 722. As such, in the illustrated embodiment, the frame 712 includes four transitions 742 that are angularly (circumferentially) separated by approximately 90 degrees. It should be appreciated, however, that the particular number, location, and/or configuration of the transitions 742 may be varied in alternative embodiments without departing from the scope of the present disclosure (e.g., depending upon the particular configuration of the mounting member 604).

In the illustrated embodiment, the accessory 700 (i.e., the transitions 742) are configured for engagement (contact) with the radial mounts 614 upon counterclockwise rotation. Embodiments in which the configuration of the transitions 742 may be reversed (i.e., such that the transitions 742 are configured for engagement (contact) with the radial mounts 614 upon clockwise rotation) are also envisioned herein, however, and would not be beyond the scope of the present disclosure.

As seen in FIG. 12, the transitions 742 include opposite (first and second) ends 744, 746, which respectively correspond to the ends 732, 736 of the ramped sections 722 and the pockets 734 and define thicknesses (heights) Tt. The thicknesses Tt extend in generally parallel relation to the optical axis X (FIGS. 6, 7, 12) and vary between the ends 744, 746 thereof such that the transitions 742 are tapered in configuration and are inclined in relation to the reference plane P. More specifically, the thicknesses Tt decrease gradually (e.g., uniformly) from the end 744 towards the end 746 such that the transitions 742 and the ramped sections 722 taper in opposite directions.

In the illustrated embodiment, the ramped sections 722 are configured so as to subtend (acute) angles β with the reference plane P that lie substantially within the range of approximately 10 degrees to approximately 45 degrees. Embodiments in which the accessory 700 may be configured such that the angles β lie outside the disclosed range are also envisioned herein, however, and would not be beyond the scope of the present disclosure.

During connection of the accessory 700 (i.e., clockwise rotation), engagement of the radial mounts 614 with the transitions 742 facilitates and guides insertion of the radial mounts 614 into the pockets 734. By contrast, during disconnection of the accessory 700 (i.e., counterclockwise rotation), by virtue of the increasing thicknesses Tt of the transitions 742 in the counterclockwise direction, engagement of the radial mounts 614 with the transitions 742 inhibits (if not entirely prevents) rotation of the accessory 700 until the application of a (predetermined) threshold force, which inhibits (if not entirely prevents) inadvertent (unintended) disconnection of the accessory 700. Upon the application of the threshold force, the radial mounts traverse the transitions 742, whereby the accessory 700 is displaced axially inward (i.e., towards the mounting member 604).

In various embodiments of the accessory 700, it is envisioned that the severity of the angles β may be altered in order to alter the force required to disconnect the accessory 700 and/or the axial displacement experienced by the accessory 700.

The stops 726 are positioned (located) adjacent to the haptic components 724 and are in communication therewith such that the slots 720 are defined by and extend between angularly (circumferentially) adjacent ramped sections 722 and stops 726. As such, in the illustrated embodiment, the frame 712 includes four stops 726 that are angularly (circumferentially) separated by approximately 90 degrees. It should be appreciated, however, that the particular number, location, and/or configuration of the stops 726 may be varied in alternative embodiments without departing from the scope of the present disclosure (e.g., depending upon the particular configuration of the mounting member 604).

The stops 726 are configured for engagement (contact) with the radial mounts 614 to thereby prevent continued (clockwise) rotation of the accessory 700 and, thus, define a maximum (rotational) range of motion for the accessory 700. The stops 726 extend radially inward from the inner wall 718 (i.e., towards the optical axis X (FIGS. 6, 7, 12)) in generally orthogonal (perpendicular) relation to the base walls 740 and in generally parallel relation to the optical axis X. More specifically, the stops 726 are positioned (located) adjacent to the ends 738 of the pockets 734 such that, upon entering the pockets 734, continued rotation of the accessory 700 causes the radial mounts 614 to interface with (i.e., engage, contact) the stops 726.

During connection and disconnection, the accessory 700 is rotatable through a range of motion R (FIG. 8) that is less than 90 degrees. More specifically, in the illustrated embodiment, due to the configuration and the angular (circumferential) separation of the slots 720, the ramped sections 722, and the haptic components 724 (i.e., the pockets 734), the accessory 700 is configured such that the range of motion R lies substantially within the range of approximately 65 degrees to approximately 85 degrees. Embodiments in which the accessory 700 may be configured such that the range of motion R lies outside of the disclosed range are also envisioned herein (e.g., depending upon the particular configuration of the mounting member 604), however. For example, an embodiment in which the accessory 700 may be configured such that the range of motion R is greater than 90 degrees (e.g., approximately 120 degrees to approximately 170 degrees) would not be beyond the scope of the present disclosure.

The sleeve 714 extends about and is connected (secured) to the frame 712 and includes a compliant (e.g., flexible, resilient material). More specifically, in the illustrated embodiment, the sleeve 714 includes silicone that is overmolded to the frame 712. Alternative materials of construction and/or methods of connecting the sleeve 714 to the frame 712 are also envisioned herein, however, and would not be beyond the scope of the present disclosure.

As seen in FIG. 8, the sleeve 714 includes an inner (bottom) flange 748, which extends radially inward (i.e., towards the optical axis X) and includes cutouts 750 that are configured in correspondence with (i.e., mirror) the slots 720. The cutouts 750 are configured to receive the radial mounts 614 (FIG. 7) when the accessory 700 is in the disengaged position, as seen in FIG. 7. As such, in the illustrated embodiment, the sleeve 714 includes four cutouts 750 that are angularly (circumferentially) separated by approximately 90 degrees. It should be appreciated, however, that the particular number, location, and/or configuration of the cutouts 750 may be varied in alternative embodiments without departing from the scope of the present disclosure (e.g., depending upon the particular configuration of the mounting member 604).

With reference now to FIGS. 5-12, methods of assembling and disassembling the image capture system 500 (i.e., connecting the accessory 700 to the image capture apparatus 600 and disconnecting the accessory 700 from the image capture apparatus 600) will be discussed.

Initially, the accessory 700 is oriented in the disengaged position (FIG. 7) such that the cutouts 750 (FIG. 8) and the slots are generally aligned with the radial mounts 614 (FIGS. 7, 9), which allows the radial mounts 614 to pass through the cutouts 750 and the slots 720 upon axial advancement of the accessory 700 towards the image capture apparatus 600 (i.e., along the optical axis X (FIGS. 6, 7, 12)). As the radial mounts 614 pass through the cutouts 750 and the slots 720, the radial mounts 614 engage (contact) the awnings 728 and are positioned adjacent to the ramped sections 722 in general axial alignment therewith (i.e., along the optical axis X).

Following alignment of the radial mounts 614 and the slots 720, the accessory 700 is rotated (clockwise) from the disengaged position(FIG. 7) towards the engaged position (FIG. 9), whereby the radial mounts 614 engage (contact) and traverse the ramped sections 722. Due to the increasing thicknesses Tr of the ramped sections 722 (in the clockwise direction), as rotation of the accessory 700 continues, a bearing effect is created that displaces the accessory 700 axially inward (i.e., towards the body 102, along the optical axis X). Axially inward displacement of the accessory 700 results in compression of the sleeve 714 against the image capture apparatus 600, which creates an internal biasing force that is directed axially outward (i.e., away from the body 102, along the optical axis X) and obviates any need to apply an axial (pushing) force to the accessory 700 during connection. In certain embodiments, it is envisioned that compression of the sleeve 714 against the image capture apparatus 600 may further facilitate sealing of the image capture system 500 in order to further inhibit (if not entirely prevent) the ingress of water, dirt, debris, etc.

Continued rotation of the accessory 700 causes the radial mounts 614 to traverse the transitions 742, upon which, the radial mounts 614 are brought into angular (circumferential) alignment with and engage (contact) the haptic components 724 as the accessory 700 is repositioned into the engaged position. As the radial mounts 614 traverse the transitions 742 and enter the pockets 734, the accessory 700 is displaced axially outward, which provides the (tactile and audible) indications of proper connection discussed above.

As seen in FIG. 9, in the engaged position, continued rotation of the accessory 700 is prevented via engagement (contact) between the radial mounts 614 and the stops 726, which prevents over-rotation of the accessory 700 and over-compression of the sleeve 714.

To disconnect the accessory 700 from the image capture apparatus 600, the accessory 700 is rotated (counterclockwise), whereby the radial mounts 614 engage (contact) and traverse the transitions 742, whereupon continued rotation of the accessory 700 is inhibited (if not entirely prevented) until the threshold force is applied to the accessory 700. Upon the application of the threshold force, the radial mounts 614 traverse the transitions 742 and engage (contact) the ramped sections 722. As rotation continues, the radial mounts 614 traverse the ramped sections 722 as the accessory 700 is repositioned into the disengaged position, during which, the accessory 700 is displaced axially outward due to the decreasing thicknesses Tr of the ramped sections 722 (in the counterclockwise direction), which is further facilitated by the biasing force in the sleeve 714 created during compression and reduces (if not entirely obviates) any need to apply an axial (pulling) force to the accessory 700 during disconnection. The axially outward displacement of the accessory 700 experienced during disconnection reduces the force required to continue rotation and thereby provides a tactile indication of proper disconnection from the image capture apparatus 600, which may be supplemented by an audible indication resulting from engagement (contact) between the radial mounts 614 and the ramped sections 722 as the radial mounts 614 traverse the transitions 742.

Upon return of the accessory 700 to the disengaged position, the radial mounts 614 are again aligned with the slots 720 and the cutouts 750, which allows the accessory 700 to be separated from the image capture apparatus 600 (i.e., the mounting member 604).

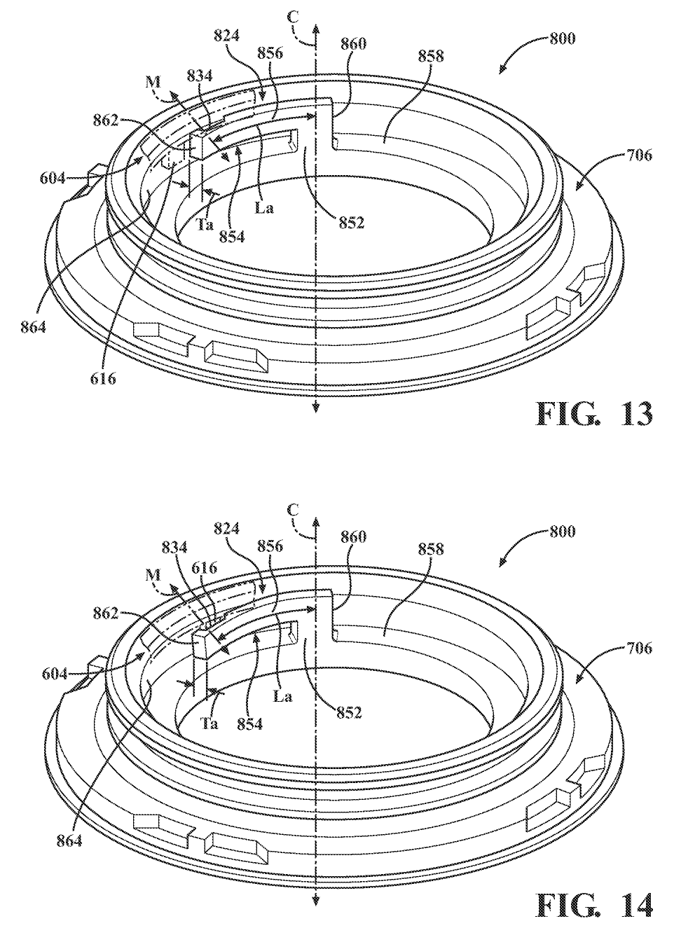

With reference now to FIGS. 13 and 14, another embodiment of the accessory will be discussed, which is identified by the reference character 800. More specifically, FIG. 13 is a partial, rear, perspective view of the accessory 800, which is shown with the mounting member 604 and in the disengaged position, and FIG. 14 is a partial, rear, perspective view of the accessory 800, which is shown with the mounting member 604 and in the engaged position. The accessory 800 includes features similar to the aforedescribed accessory 700 (FIGS. 5-12) and, accordingly, will only be discussed with respect to differences therefrom in the interest of brevity. As such, identical reference characters will be utilized to refer to elements, structures, features, etc., common to the accessories 700, 800.

The accessory 800 includes (one or more) at least one haptic component 824, which, like the haptic components 724 (FIGS. 11, 12), provide tactiles (and audible) indications of proper connection (and disconnection). Although shown as including a single haptic component 824, embodiments of the accessory 800 that include two or more haptic components 824 are also envisioned herein and would not be beyond the scope of the present disclosure. For example, it is envisioned that the inclusion of one or more additional haptic components 824 may increase symmetry, inhibit tilt of the accessory 800, and/or increase the surface area in contact with the image capture apparatus 600 (i.e., the mounting member 604), thereby increasing feedback.

The haptic component 824 includes a support 852 and an arm 854 (e.g., a leaf spring 856), each of which is integrally (unitarily, monolithically) formed with the barrel 706 such that the barrel 706, the support 852, and the arm 854 are from a single piece of (non-metallic) material.

The support 852 extends axially from the barrel 706 along an axis of connection C that is oriented in generally parallel relation to the optical axis X (FIGS. 6, 7, 12). More specifically, the support 852 extends from an inner (circumferential) base wall 858 of the barrel 706, which extends radially inward (i.e., towards the optical axis X).

The arm 854 extends radially from the support 852 and includes: a first end 860, which is fixedly connected (secured) to the support 852; a second, free end 862, which is movable in relation to the support 852, the barrel 706, and the mounting member 604; and a pocket 834, which is positioned (located) between the ends 860, 862 and extends radially inward into the arm 854 (i.e., towards the optical axis X, in generally orthogonal (perpendicular) relation thereto).

The haptic component 824 is configured to interface with (i.e., engage, contact) a corresponding detent (projection) 616 on the mounting member 604 during repositioning (i.e., rotation) of the accessory 800 between the disengaged position (FIG. 13) and the engaged position (FIG. 14). In contrast to the haptic components 724 discussed above in connection with the accessory 700 (FIGS. 5-12), the haptic component 824 includes a dynamic configuration such that, during connection and disconnection of the accessory 800, the haptic component 824 is resiliently repositioned between a (first) normal position (FIG. 13) and a (second) deflected position (FIG. 14). More specifically, during repositioning between the normal and deflected positions, the haptic component 824 is deflected radially along an axis of movement M that is oriented in generally orthogonal (perpendicular) relation to the axis of connection C.

In the normal position (FIG. 13), the arm 854 is generally flush with an inner (circumferential) wall 864 of the barrel 706, which extends axially from the base wall 858 (i.e., in generally parallel relation to the optical axis X). As the accessory 800 is rotated from the disengaged position into the engaged position, the arm 854 is brought into engagement (contact) with the detent 616, which inhibits (if not entirely prevents) continued rotation of the accessory 800 until the application of a (predetermined) threshold force. Upon the application of the threshold force, the arm 854 is deflected radially inward (i.e., toward the optical axis X), which creates a biasing force in the arm 854 as the haptic component 824 is moved into the deflected position. Continued rotation of the accessory 800 brings the pocket 834 into angular (circumferential) alignment with detent 616, as seen in FIG. 14, whereupon the arm 854 is deflected radially inward (i.e., towards the optical axis X) as the haptic component 824 returns to the normal position under the influence of the biasing force such that the detent 616 is received by the pocket 834. Reception of the detent 616 by the pocket 834 results in a force reduction, which provides a tactile indication that the accessory 800 has been properly connected (secured) to the mounting member 604 that may be supplemented by an audible indication resulting from engagement (contact) between the arm 854 and the detent 616.

As a result of the radial repositioning of the arm 854, in contrast to use and operation of the haptic components 724 (FIGS. 11, 12), use and operation of the haptic component 824 results in local deflection only and causes neither compression nor expansion of the sleeve.

In the illustrated embodiment, the arm 854 defines a thickness Ta that lies substantially within the range of approximately .2mm to approximately .5mm and a length La that lies substantially within the range of approximately 5mm to approximately 20mm. It is envisioned, however, that the specific configuration (e.g., the dimensions) of the arm 854 may be varied in alternative embodiments in order to increase or decrease the threshold force required to rotate the accessory 800 between the disengaged position and the engaged position. As such, embodiments in which the thickness Ta and/or the length La may lie outside of the disclosed range are also envisioned herein and would not be beyond the scope of the present disclosure.

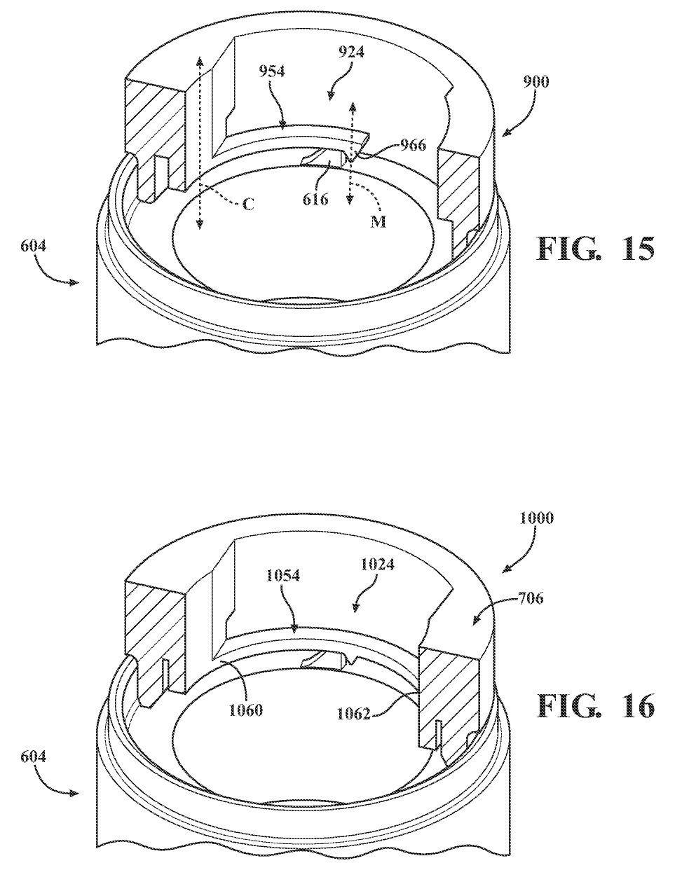

With reference now to FIG. 15, another embodiment of the accessory will be discussed, which is identified by the reference character 900. More specifically, FIG. 15 is a partial, front, cross-sectional view of the accessory 900, which is shown in perspective view with the mounting member 604, in the engaged position. The accessory 900 includes features similar to the aforedescribed accessory 800 (FIGS. 13, 14) and, accordingly, will only be discussed with respect to differences therefrom in the interest of brevity. As such, identical reference characters will be utilized to refer to elements, structures, features, etc., common to the accessories 800, 900.

The accessory 900 includes (one or more) at least one haptic component 924, which provides tactile (and audible) indications of proper connection (and disconnection), as discussed above. Although only a single haptic component 924 is shown in FIG. 15, embodiments of the accessory 900 that include two or more haptic components 924 are also envisioned herein and would not be beyond the scope of the present disclosure.

In contrast to the accessory 800, the haptic component 924 includes an arm 954 that is configured for axial deflection during repositioning between the normal position and the deflected position, as described in further detail below, such that the axis of movement M is oriented in generally parallel relation to the axis of connection C. As seen in FIG. 15, the arm 954 includes a detent 966 that is configured to interface with (i.e., engage, contact) the detent 616 on the mounting member 604, which extends axially outward (i.e., towards the accessory 900, along the optical axis X (FIGS. 6, 7, 12)).

As the accessory 900 is rotated from the disengaged position into the engaged position, the detents 966, 616 are brought into engagement (contact), whereupon the arm 954 is deflected axially outward (i.e., towards the accessory 900, along the optical axis X) as the haptic component 924 is moved into the deflected position. Continued rotation of the accessory 900 causes the detent 966 to traverse the detent 616, after which, the arm 954 is deflected axially inward (i.e., away from the accessory 900, along the optical axis X) as the haptic component 924 returns to the normal position. Traversal of the detent 616 results in a force reduction, which provides a tactile indication that the accessory 900 has been properly connected (secured) to the mounting member 604 that may be supplemented by an audible indication resulting from engagement (contact) between the arm 954 and the detent 616.

With reference now to FIG. 16, another embodiment of the accessory will be discussed, which is identified by the reference character 1000. More specifically, FIG. 16 is a partial, front, cross-sectional view of the accessory 1000, which is shown in perspective with the mounting member 604, in the engaged position. The accessory 1000 includes features similar to the aforedescribed accessory 900 (FIG. 15) and, accordingly, will only be discussed with respect to differences therefrom in the interest of brevity. As such, identical reference characters will be utilized to refer to elements, structures, features, etc., common to the accessories 900, 1000.

The accessory 1000 includes (one or more) at least one haptic component 1024, which provides tactile (and audible) indications of proper connection (and disconnection), as discussed above. Although only a single haptic component 1024 is shown in FIG. 16, embodiments of the accessory 7004 that include two or more haptic components 1024 are also envisioned herein and would not be beyond the scope of the present disclosure.

In contrast to the accessory 900, the haptic component 1024 include an arm 1054 with ends 1060, 1062 that are each fixed in relation to the barrel 706, which increases the force required to deflect the haptic component 1024 (vis-à-vis the accessory 900) during rotation of the accessory 1000 from the disengaged position into the engaged position. More specifically, during rotation of the accessory 1000 from the disengaged position into the engaged position, as the haptic component 1024 is moved into the deflected position, the arm 1054 is bowed axially outward (i.e., away from the mounting member 604, along the optical axis X (FIGS. 6, 7, 12)) into a curved configuration.

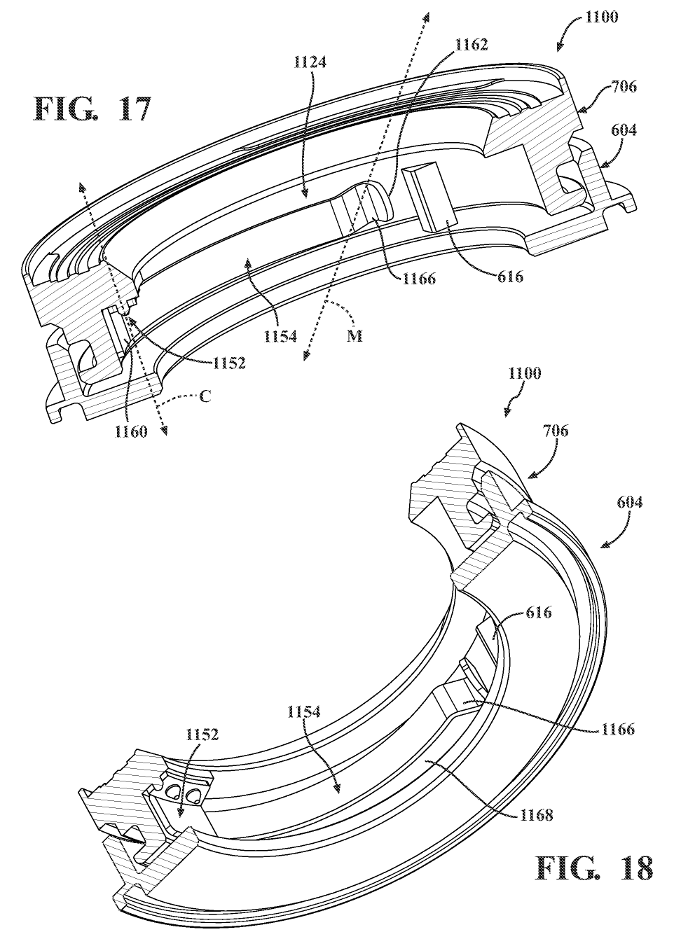

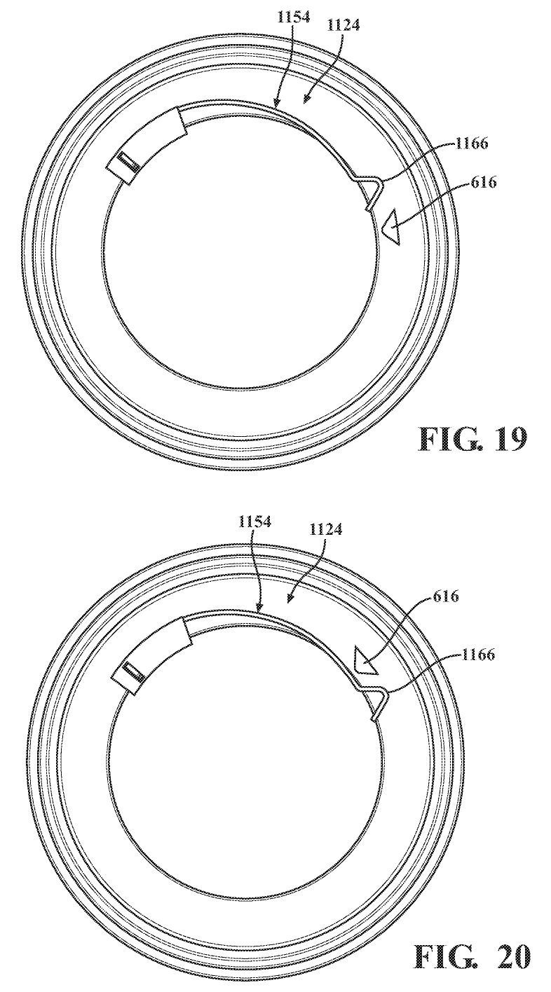

With reference now to FIGS. 17-20, another embodiment of the accessory will be discussed, which is identified by the reference character 1100. More specifically, FIG. 17 is a partial, front, cross-sectional view of the accessory 1100 and the mounting member, which are shown in perspective and with the mounting member 604 in the disengaged position; FIG. 18 is a partial, rear, cross-sectional view of the accessory 1100 and the mounting member, which are shown in perspective and with the mounting member 604 in the disengaged position; FIG. 19 is a partial, front, end view of the accessory 1100 and the mounting member 604 with the accessory 1100 shown in the disengaged position; and FIG. 20 is a partial, front, end view of the accessory 1100 and the mounting member 604 with the accessory 1100 shown in the engaged position. The accessory 1100 includes features similar to the aforedescribed accessory 800 (FIGS. 13, 14) and, accordingly, will only be discussed with respect to differences therefrom in the interest of brevity. As such, identical reference characters will be utilized to refer to elements, structures, features, etc., common to the accessories 800, 1100.

The accessory 1100 includes (one or more) at least one haptic component 1124, which provides tactile (and audible) indications of proper connection (and disconnection), as discussed above. Although only a single haptic component 1124 is shown in FIGS. 17-20, embodiments of the accessory 1100 that include two or more haptic components 1124 are also envisioned herein and would not be beyond the scope of the present disclosure.

In contrast to the accessories 800, 900, and 1000, the haptic component 1124 is configured as a discrete component that is separate from the barrel 706 and includes a support 1152 and an arm 1154.

The support 1152 extends axially from the barrel 706 (i.e., such that the axis of connection C is oriented in generally parallel relation to the optical axis X (FIGS. 6, 7, 12)) and is mechanically connected (secured) to the barrel 706. Although shown as being heat staked to the barrel 706 in the illustrated embodiment, it is envisioned that the haptic component 1124 may be connected (secured) to the barrel 706 in any manner that supports use and operation in the manner described herein (e.g., via one or more mechanical fasteners, via ultrasonic welding, etc.).

The arm 1154 is integrally (unitarily, monolithically) from a single piece of (metallic) material and includes a detent 1166. The detent 1166 is positioned (located) between the ends 1160, 1162 of the arm 1154 and extends radially outward (i.e., away from the optical axis X) such that, in contrast to the accessory 800, in the normal position, the arm 1154 is spaced from the inner wall 864 of the barrel 706 so as to define a receiving space (gap) 1168 (FIG. 18). The detent 1166 is configured to interface with (i.e., engage, contact) the detent 616 on the mounting member 604 such that the detents 1166, 616 are brought into engagement (contact) as the accessory 1100 is rotated from the disengaged position (FIGS. 17-19) into the engaged position (FIG. 20), whereupon the arm 1154 is deflected radially inward (i.e., towards the optical axis X) as the haptic component 1124 is moved into the deflected position. As seen in FIG. 20, when the accessory 1100 is in the engaged position, upon return of the haptic component 1124 to the normal position, the detent 1166 is positioned (located) within the receiving space 1168.

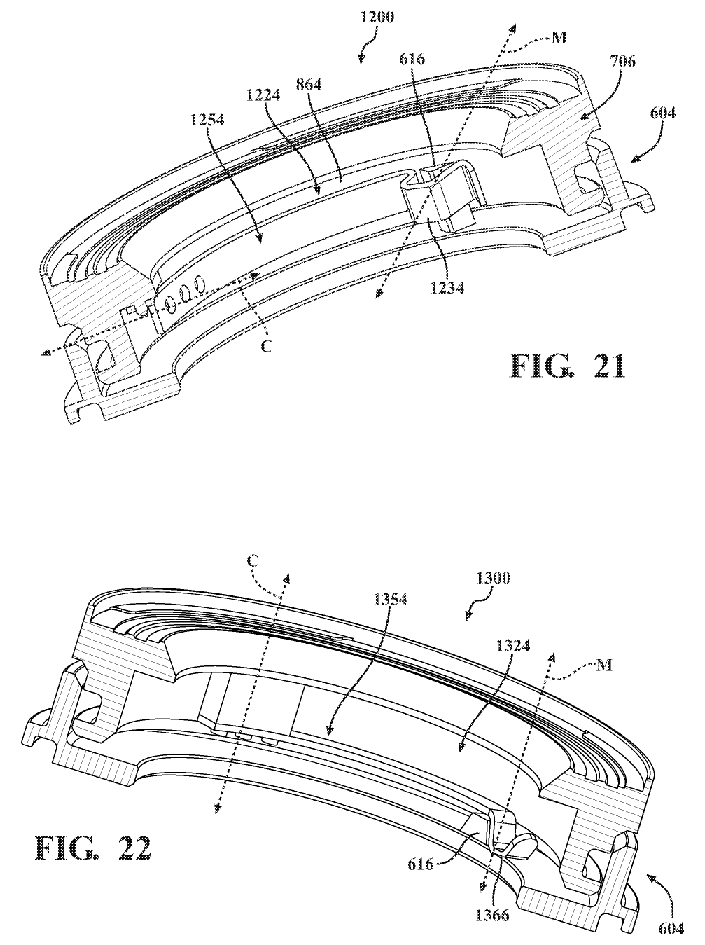

With reference now to FIG. 21, another embodiment of the accessory will be discussed, which is identified by the reference character 1200. More specifically, FIG. 21 is a partial, front, cross-sectional view of the accessory 1200 and the mounting member 604, which are shown in perspective and with the accessory 1200 in the engaged position. The accessory 1200 includes features similar to the aforedescribed accessory 1100 (FIGS. 17-20) and, accordingly, will only be discussed with respect to differences therefrom in the interest of brevity. As such, identical reference characters will be utilized to refer to elements, structures, features, etc., common to the accessories 1100, 1200.

The accessory 1200 includes (one or more) at least one haptic component 1224, which provides tactile (and audible) indications of proper connection (and disconnection), as discussed above. Although only a single haptic component 1224 is shown in FIG. 21, embodiments of the accessory 1200 that include two or more haptic components 1224 are also envisioned herein and would not be beyond the scope of the present disclosure.

In contrast to the accessory 1100, the haptic component 1224 includes an arm 1254 that is generally flush with the inner wall 864 of the barrel 706 in the normal position and is connected (secured) to the barrel 706 such that axes of connection C and movement M are each oriented radially (i.e., in generally orthogonal (perpendicular) relation to the optical axis X (FIGS. 6, 7, 12)). More specifically, as discussed in connection with the accessory 800, the arm 1254 includes a pocket 1234 that extends radially inward (i.e., towards the optical axis X, in generally orthogonal (perpendicular) relation thereto) and is configured to interface with (i.e., engage, contact) and receive the detent 616 on mounting member 604 as the accessory 1200 is rotated from the disengaged position into the engaged position.

With reference now to FIG. 22, another embodiment of the accessory will be discussed, which is identified by the reference character 1300. More specifically, FIG. 22 is a partial, front, cross-sectional view of the accessory 1300 and the mounting member 604, which are shown in perspective and with the accessory 1300 in the engaged position. The accessory 1300 includes features similar to the aforedescribed accessories 900 (FIGS. 15), 1200 (FIG. 21) and, accordingly, will only be discussed with respect to differences therefrom in the interest of brevity. As such, identical reference characters will be utilized to refer to elements, structures, features, etc., common to the accessories 900, 1200, 1300.

The accessory 1300 includes (one or more) at least one haptic component 1324, which includes an arm 1354 that provides tactile (and audible) indications of proper connection (and disconnection), as discussed above. Although only a single haptic component 1324 is shown in FIG. 22, embodiments of the accessory 1300 that include two or more haptic components 1324 are also envisioned herein and would not be beyond the scope of the present disclosure.

As discussed in connection with the accessory 900 (FIG. 15), the arm 1354 includes a detent 1366 that is configured to interface with (i.e., engage, contact) the detent 616 on the mounting member 604 and is configured for axial displacement (i.e., away from the mounting member 604, along the optical axis X (FIGS. 6, 7, 12)) as the haptic component 1324 is moved into the deflected position. More specifically, as seen in FIG. 22, the haptic component 1324 is configured such that the axis of movement M is oriented in generally parallel relation to the axis of connection C. In contrast to the accessory 900, however, the arm 1354 is configured as a discrete component that is separate from the barrel 706, as discussed above in connection with the accessory 1200 (FIG. 21).

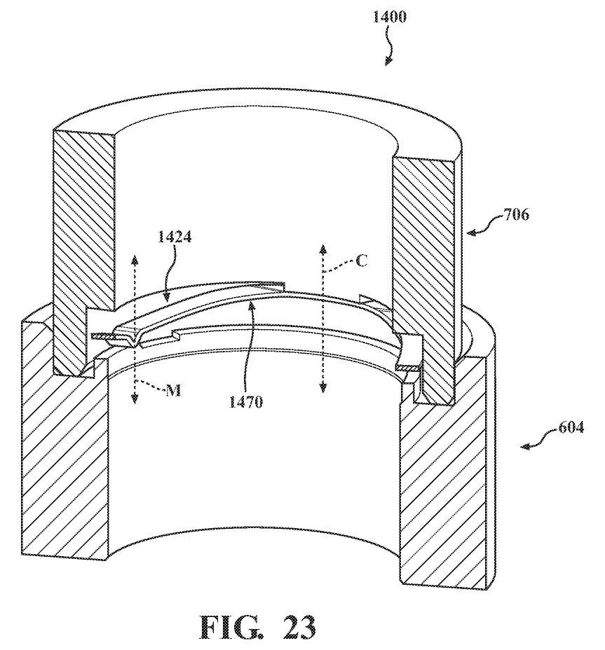

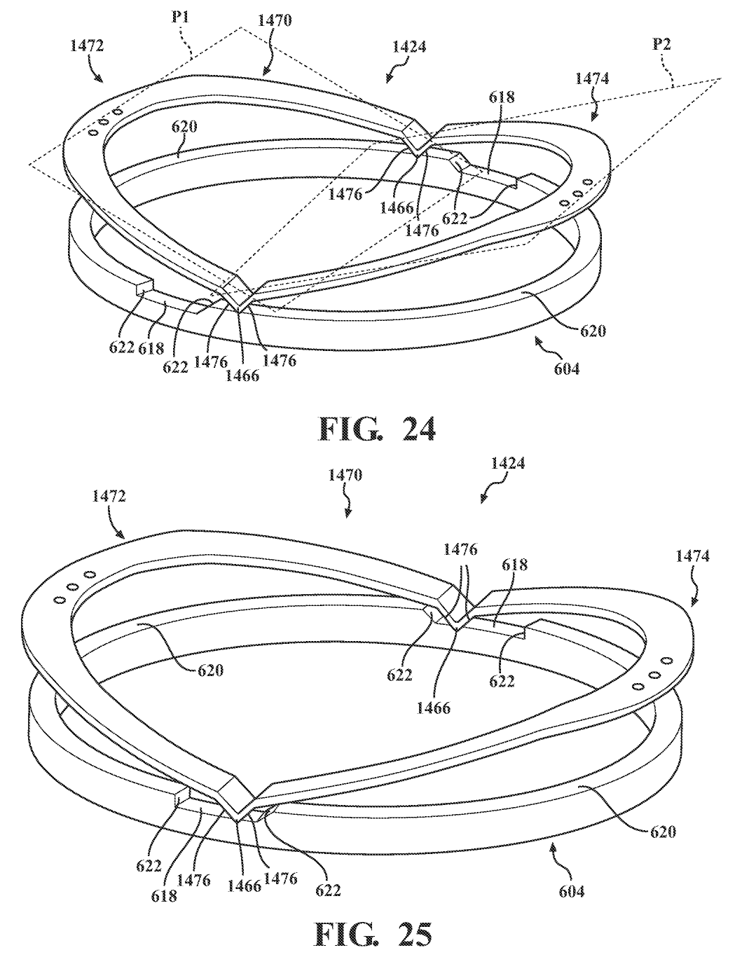

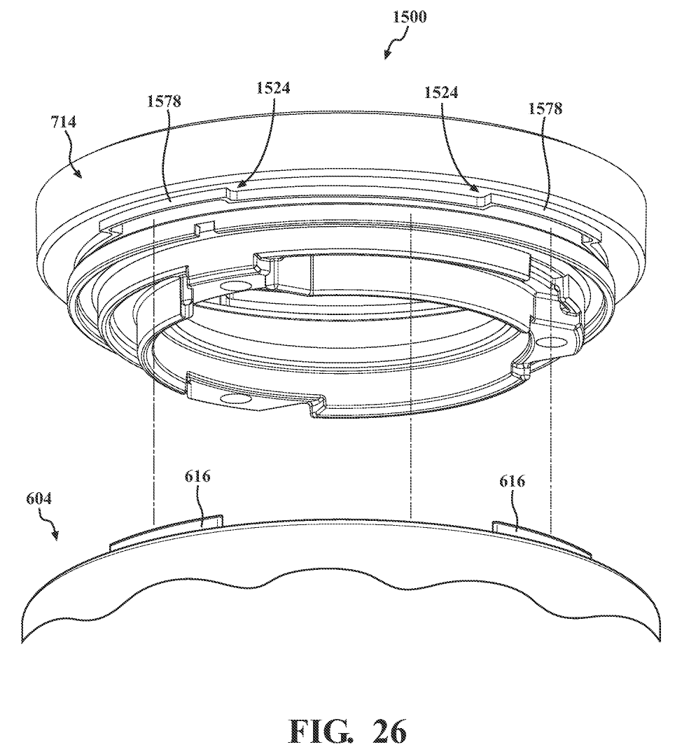

With reference now to FIGS. 23-35, another embodiment of the accessory will be discussed, which is identified by the reference character 1400. More specifically, FIG. 23 is a partial, front, cross-sectional view of the accessory 1400 and the mounting member 604, which are shown in perspective and with the accessory 1400 in the disengaged position; FIG. 24 is a partial, front, perspective view of the accessory 1400 and the mounting member 604 with the accessory 1400 shown in the disengaged position and separated from the barrel 706; and FIG. 25 is a partial, front, perspective view of the accessory 1400 and the mounting member 604 with the accessory 1400 shown in the engaged position and separated from the barrel 706. The accessory 1400 includes features similar to the aforedescribed accessory 1300 (FIG. 22) and, accordingly, will only be discussed with respect to differences therefrom in the interest of brevity. As such, identical reference characters will be utilized to refer to elements, structures, features, etc., common to the accessories 1300, 1400.

The accessory 1400 includes (one or more) at least one haptic component 1424, which provides tactile (and audible) indications of proper connection (and disconnection), as discussed above. Although only a single haptic component 1424 is shown in FIGS. 23-25, embodiments of the accessory 1400 that include two or more haptic components 1424 are also envisioned herein and would not be beyond the scope of the present disclosure.

The haptic component 1424 includes a spring member 1470 that is generally arcuate (curved) in configuration and is configured such that the axis of movement M is oriented in generally parallel relation to the axis of connection C. The spring member 1470 includes a (first) segment (portion, half) 1472 that extends along a (first) plane P1 and a (second) segment (portion, half) 1474 that extends along a (second) plane P2, which intersects the plane P1. At the intersection of planes P1, P2 the haptic component 1424 includes detents 1466, which are configured to interface with (i.e., engage, contact) the mounting member 604 via insertion into corresponding grooves 618, which extend axially into the mounting member 604 (i.e., in generally parallel relation to the optical axis X (FIGS. 6, 7, 12)) so as to define shoulders 620 that extend therebetween. More specifically, when the accessory 1400 is in the disengaged position (FIGS. 23, 24), the detents 1466 engage (contact) the shoulders 620, which facilitates rotation of the accessory 1400, and in the engaged position (FIG. 25), the detents 1466 are received by the grooves 618, thereby providing tactile (and audible) indications of proper connection (and disconnection) of the accessory 1400.

In order to facilitate reconfiguration of the accessory 1400 from the engaged position into the disengaged position, the detents 1466 and the grooves 618 include corresponding tapered configurations. More specifically, the detents 1466 include (angled) outer walls 1476 that are configured in correspondence with (mirror) (angled) inner walls 622 defined by the grooves 618 such that, upon the application of a (predetermined) threshold force to the accessory 1400, the outer walls 1476 bear against the inner walls 622 to thereby remove the detents 1466 from the grooves 618 and allow for continued rotation of the accessory 1400 in relation to the mounting member 604.

With reference now to FIG. 26, another embodiment of the accessory will be discussed, which is identified by the reference character 1500. More specifically, FIG. 26 is a rear, perspective view of the accessory 1500 and the mounting member 604 with the accessory 1500 shown in the disengaged position. The accessory 1500 includes features similar to the aforedescribed accessory 700 and, accordingly, will only be discussed with respect to differences therefrom in the interest of brevity. As such, identical reference characters will be utilized to refer to elements, structures, features, etc., common to the accessories 700, 1500.

In contrast to the previous embodiments, in which the haptic components 824, 924, 1024, 1124, 1224, 1324, 1424 are associated with the barrel 706, the accessory 1500 includes haptic components 1524 that are associated with the sleeve 714. Although shown as including four haptic components 1524 in FIG. 26, it should be appreciated that the particular position and number of haptic components 1524 may be varied in alternative embodiments without departing from the scope of the present disclosure (e.g., depending upon the particular configuration of the mounting member 604). For example, embodiments of the accessory 1500 that include a single haptic component 1524 are also envisioned herein and would not be beyond the scope of the present disclosure.

The haptic components 1524 include receptacles 1578, which are configured to interface with (i.e., engage, contact) the mounting member 604 (or the body 102 (FIG. 5) of the image capture apparatus 600). More specifically, the receptacles 1578 are configured to receive corresponding detents 616 on the mounting member 604, which extend axially outward therefrom (i.e., toward the accessory 1500, in generally parallel relation to the optical axis X), when the accessory 1500 is in the engaged position, thereby providing tactile (and audible) indications of proper connection (and disconnection) of the accessory 1500.

While the present disclosure has been described in connection with certain embodiments, it is to be understood that the present disclosure is not to be limited to the disclosed embodiments, but, on the contrary, is intended to cover various modifications and equivalent arrangements included within the scope of the appended claims, which scope is to be accorded the broadest interpretation to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “generally,” “approximately,” “substantially,” and the like should be understood to include the numerical range, concept, or base term with which they are associated as well as variations in the numerical range, concept, or base term on the order of up to 25% (e.g., to allow for manufacturing tolerances and/or deviations in design). For example, the term “generally parallel” should be understood as referring to an arrangement in which the pertinent components (structures, elements) subtend an angle therebetween that is equal to 180° as well as an arrangement in which the pertinent components (structures, elements) subtend an angle therebetween that is greater than or less than 180° (e.g., ±10%, ±15%, ±25%). The term “generally parallel” should thus be understood as encompassing configurations in which the pertinent components are arranged in parallel relation. Similarly, the term “generally identical” should be understood as encompassing configurations in which the pertinent components are identical in configuration as well as configurations in which there may be insubstantial variations between the pertinent components that do not influence the substantive construction or performance thereof.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure, etc.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. An image capture system comprising:
an image capture apparatus including:
a body; and
a mounting member connected to the body; and
an accessory configured for releasable connection to the mounting member, wherein the accessory includes at least one haptic component configured to provide an indication of positive connection of the accessory to the mounting member.

2. The image capture system of claim 1, wherein the accessory includes at least one optical element.

3. The image capture system of claim 1, wherein the at least one haptic component defines a pocket configured to receive the mounting member.

4. The image capture system of claim 3, wherein the pocket extends in generally parallel relation to an optical axis of the image capture apparatus.

5. The image capture system of claim 3, wherein the pocket extends radially inward towards an optical axis of the image capture apparatus.

6. The image capture system of claim 1, wherein the at least one haptic component includes a static configuration.

7. The image capture system of claim 1, wherein the at least one haptic component includes a dynamic configuration and is resiliently repositionable between a normal position and a deflected position.

8. The image capture system of claim 7, wherein the at least one haptic component includes a first end, which is fixedly connected to the accessory, and a second, free end.

9. The image capture system of claim 8, wherein the at least one haptic component is configured for axial deflection during repositioning between the normal position and the deflected position.

10. The image capture system of claim 8, wherein the at least one haptic component is configured for radial deflection during repositioning between the normal position and the deflected position.

11. An accessory configured for use with an image capture apparatus including a mounting member, the accessory comprising:
a frame including:
slots configured to receive radial mounts on the mounting member;
ramped sections in communication with the slots; and
haptic components in communication with the ramped sections such that rotation of the accessory causes the radial mounts to engage the ramped sections and, thereafter, the haptic components to thereby provide an indication of positive connection of the accessory to the mounting member.

12. The accessory of claim 11, wherein the frame further includes:
stops configured for engagement with the mounting member to thereby inhibit continued rotation of the accessory, wherein the stops are positioned adjacent to the haptic components.

13. The accessory of claim 11, wherein the ramped sections are configured such that rotation of the accessory causes axial displacement thereof in relation to the mounting member.

14. The accessory of claim 13, wherein the accessory further includes:
a sleeve extending about the frame and including a compliant material such that axial displacement of the accessory causes compression and expansion of the sleeve.

15. The accessory of claim 13, wherein the haptic components define pockets configured to receive the radial mounts.

16. The accessory of claim 15, wherein the pockets are axially offset in relation to the ramped sections along an optical axis of the image capture apparatus.

17. The accessory of claim 16, wherein the pockets include base walls extending in generally orthogonal relation to the optical axis.

18. An accessory configured for use with an image capture apparatus including a mounting member, the accessory comprising:
a barrel;
a lens connected to the barrel;
a frame connected to the barrel and configured to interface with radial mounts on the mounting member such that the accessory is rotatable in relation to the mounting member between a disengaged position, in which the accessory is connectable to and disconnectable from the image capture apparatus, and an engaged position, in which the accessory is connected to the image capture apparatus via the mounting member, wherein the frame includes:
slots extending axially into the frame in generally parallel relation to an optical axis of the image capture apparatus, wherein the slots are configured to receive the radial mounts;
ramped sections in communication with the slots and configured to engage the radial mounts such that the accessory is displaced axially during rotation between the disengaged position and the engaged position; and
haptic components in communication with the ramped sections, wherein the haptic components are configured to interface with the radial mounts to thereby provide an indication of positive connection of the accessory to the mounting member; and
a sleeve extending about the frame and including a compliant material such that axial displacement of the accessory causes compression and expansion of the sleeve.

19. The accessory of claim 18, wherein the haptic components define pockets configured to receive the radial mounts.

20. The accessory of claim 18, wherein the accessory is configured for rotation through an angular range of motion less than 90 degrees during rotation between the disengaged position and the engaged position.
